(19) United States
(12) Patent Application Publication
(10) Pub. No.: US 2013/0202375 A1
(43) Pub. Date: Aug. 8, 2013

(54) INDEXABLE DRILL INSERT, A DRILLING TOOL AND A METHOD OF ASSEMBLING THEREOF

(71) Applicant: KARTHIC RAMESH, Bangalore (IN)

(72) Inventor: KARTHIC RAMESH, Bangalore (IN)

(21) Appl. No.: 13/365,954

(22) Filed: Feb. 3, 2012

(51) Int. Cl. B23B 51/02; B23B 27/16; B23P 11/00; B23B 27/22

(52) U.S. Cl. 408/200; 407/113; 407/114; 29/525.11

(57) ABSTRACT

The present disclosure relates to a drilling tool, more particularly to drill insert of trigon shape with plurality of cutting edges. The indexable drill insert (1) having trigon shape, comprising an upper side (1b) and lower side (1c), parallel to each other, characterized in that, a mounting hole (1a) at center of the drill insert (1), enabling the indexable insert (1) to be mounted on both upper side (1b) and lower side (1c) of the insert (1); and plurality of cutting edges (1d) on each side of the insert (1).

### TECHNICAL FIELD

Embodiments of the present disclosure relate to a drilling tool. More particularly the embodiments relate to drill insert of trigon shape with plurality of cutting edges.

### BACKGROUND

Drilling tools typically employ inserts for drilling process. The existing inserts used in the drilling tools are triangular insert and have three cutting edges. After using the inserts for certain duration, the cutting edges will wear out. Hence, the inserts have to be indexed and then after all 6 cutting edges are worn out, replaced with fresh inserts.

In indexable drills having normal mounting of inserts, the threads of the inserts are engaged to the screw. The screw in the drill is taped to about 1.5 threads to 2 threads as amount of material for tapping in the drill body reduces.

In light of foregoing discussion, there is need for a drill insert having more than one cutting edge to overcome the limitation.

### STATEMENT OF THE DISCLOSURE

Accordingly, the present disclosure provides an indexable drill insert having trigon shape, comprising an upper side and lower side, parallel to each other, characterized in that, a mounting hole at center of the drill insert, enabling the insert to be mounted on both upper side and lower side of the insert; and plurality of cutting edges on each side of the insert, and relates to a drilling tool comprising an indexable drill insert having trigon shape, comprising an upper side and lower side, parallel to each other, characterized in that, a mounting hole at center of the drill insert, enabling the insert to be mounted on both upper side and lower side of the insert; and plurality of cutting edges on each side of the insert, and a drill body with drill flutes and drill pockets at the flute end, said drill pockets are configured to accommodate to the indexable drill inserts; wherein said indexable drill inserts are tangentially mounted in the drill pockets, and also provides for a method of assembling drilling tool, comprising mounting indexable drill inserts tangentially in drill pockets of the drilling tool; and fastening the indexable drill inserts with the drilling tool using screws.

### SUMMARY OF THE DISCLOSURE

The shortcomings of the prior art are overcome and additional advantages are provided through the provision of drill insert as claimed in the present disclosure. Additional features and advantages are realized through the techniques of the present disclosure. Other embodiments and aspects of the disclosure are described in detail herein and are considered a part of the claimed disclosure.

In one embodiment, the disclosure provides for an indexable drill insert having trigon shape, comprising an upper side and lower side, parallel to each other, characterized in that, a mounting hole at center of the drill insert, enabling the indexable insert to be mounted on both upper side and lower side of the insert; and plurality of cutting edges on each side of the insert.

In one embodiment, the indexable drill insert comprise six cutting edges and has included angle between adjacent cutting edge is ranging from about 70° to about 90°, and an angle between two parts of the same cutting edge ranging from about 140° to about 180°.

In one embodiment, angle between upper side and a rake face is ranging from about 50° to about 90°.

In one embodiment, the upper side and the lower side have three cutting edges each.

In one embodiment, a drilling tool comprising an indexable drill insert having trigon shape, comprising an upper side and lower side, parallel to each other, characterized in that, a mounting hole at center of the drill insert, enabling the insert to be mounted on both upper side and lower side of the insert; and plurality of cutting edges on each side of the insert, and a drill body with drill flutes and drill pockets at the flute end, said drill pockets are configured to accommodate to the indexable drill inserts; wherein said indexable drill inserts are tangentially mounted in the drill pockets.

In one embodiment, the indexable drill insert comprise six cutting edges and has included-angle ranging from about 70° to about 90° and an angle between two parts of the same cutting edge ranging from about 140° to about 180°.

In one embodiment, the upper side and the lower side of the drill insert has three cutting edges each.

In one embodiment, the disclosure provides for a method of assembling drilling tool, comprising mounting indexable drill inserts tangentially in drill pockets of the drilling tool; and fastening the indexable drill inserts with the drilling tool using screws.

In one embodiment, the drill inserts are mounted in such a manner that axis of the screw is substantially parallel to axis of the drilling tool.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The features of the present disclosure will become more fully apparent from the following description and appended claims, taken in conjunction with the accompanying drawings. Understanding that these drawings depict only several embodiments in accordance with the disclosure and are therefore not to be considered limiting of its scope; the disclosure will be described with additional specificity and detail through use of the accompanying drawings.

FIG. 1 shows top view of the drill insert according to the disclosure;

FIG. 2 shows side view of the drill insert according to the disclosure;

FIG. 3 shows perspective view of the drill insert according to the disclosure;

FIGS. 4a, 4b, 4c shows a drilling tool with inserts according to the disclosure;

FIGS. 5a and 5b shows perspective views of assembled indexable drill insert with drilling body according to the disclosure;

FIGS. 6a and 6b shows perspective views of assembling the indexable drill insert with drilling body according to the disclosure;

FIG. 7 shows the drilling tool having fastening means parallel with the drilling tool axis according to the disclosure;

FIG. 8 shows bottom view of the drilling tool having tangentially mounted trigon shaped drill inserts according to the disclosure; and

FIG. 9 shows seating faces in the pocket according to the instant disclosure.

### DETAILED DESCRIPTION

In the following detailed description, reference is made to the accompanying figures, which form a part hereof In the figures, similar symbols typically identify similar components, unless context dictates otherwise. The illustrative embodiments described in the detailed description, and figures. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, and designed in a wide variety of different configurations, all of which are explicitly contemplated and make part of this disclosure.

This disclosure is drawn inter-alia, to a drill insert. More particularly, embodiment of the disclosure relates to indexable drill inserts having trigon shape.

### REFERRAL NUMERALS

1: indexable drill insert,

1a: mounting hole of the drill insert,

1b: upper side of the drill insert,

1c: lower side of the drill insert,

1d: cutting edges of the drill insert,

1e: contact faces of the drill insert,

2: drilling tool,

3: drill body,

4: drill flute,

5: drill inserts pockets,

6: screw,

7: screw hole in the insert pocket,

8: chip gash area on the flute,

α: included angle between upper side (1b) and rake face,

β: included angle between two parts of the same cutting edge,

θ: included angle between adjacent cutting edge,

S1, S2, S3, S4, S5 and S6: Sides on the drill insert,

H1, H3 and H5: Cutting edges of drill insert on lower side of the drill insert,

H2, H4 and H6: Cutting edges of drill insert on upper side of the drill insert, and

R1, R2, R3, R4, R5, R6, R7, R8, R9, R10, R11, and R12: Rake portion of the indexable drill insert.

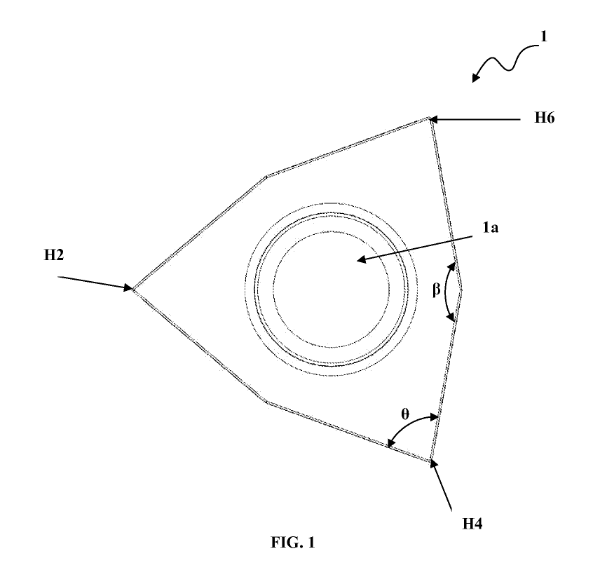

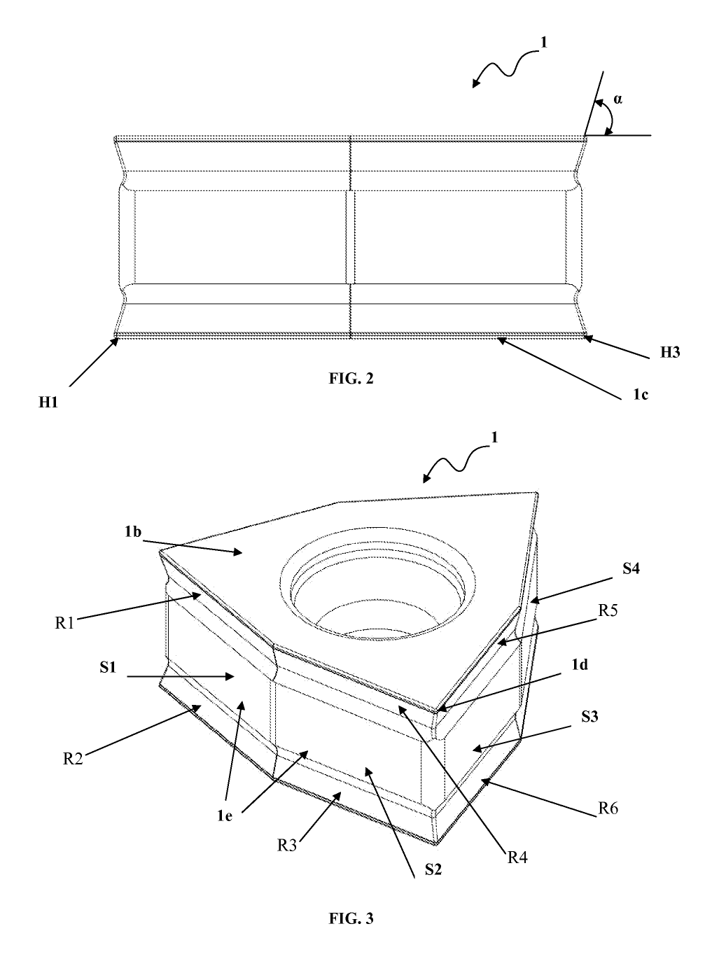

With reference to FIGS. 1-9, a double-sided or indexable drill insert is shown in accordance to the present disclosure. The insert is a trigon-shaped which is manufactured from directly pressed cemented carbide.

In one embodiment, FIGS. 1, 2 and 3 illustrates top, side and perspective views of a trigon-shaped drill insert respectively. The insert is substantially triangular; each side of the triangle is broken outward from the center of the triangle in order to form two sides of each side of the triangle. Thus the insert has obtained six corners, wherein the tip angles of the triangle having been made more obtuse. Another way of describing a trigon-shaped drill insert is that an imaginary circle inscribed in the drill insert touches the periphery of the drill insert in six points. Thus, the drill insert comprises six sides S1, S2, S3, S4 S5, S6, each one of which comprises a major cutting edge, H1, H2, H3, H4, H5, H6. The three major cutting edges H2, H4, H6 are shown in FIG. 1 in direct connection with an upper side. While the other three major cutting edges H1, H3, H5 are found on the lower side of the drill insert. For mounting of the drill insert in a drill insert pocket (5), a mounting hole (1a), including the axis thereof, is provided centrally in the drill insert (1).

In one embodiment, for example, the included angle (α) of the cutting edges is ranging from about 70° to about 90° and while the angle (β) between the same cutting edge parts of same side is ranging from about 140° to about 180°. The included angle (θ) between adjacent cutting edges is ranging from about 50° to about 90°. The insert is a negative insert, and has no clearance angle over the cutting edges. This enables indexing the insert three times when it rests on one face and another three times when it rests on the other face. The contact faces will rest against the pocket walls in the steel drill body. The rake angle and the included angle over the cutting edge are complimentary. If the rake angle is 13°, then the included angle (α) is 77°. If the rake angle is 15°, then the included angle (α) is 75°. The indexable drill insert has rake portion represented R1, R2, R3, R4, R5, R6, R7, R8, R9, R10, R11, and R12.

In one embodiment, the trigon inserts are much stronger as compared to that of Triangular inserts as its included angle (α) is higher (80° in case of trigon when compared to 60° in case of triangular). As the inserts are without any clearance angle over the cutting edge, this enables to provide twice the number of cutting edges as compared to a positive insert (insert with clearance angle over the cutting edge). Also, since it is a negative insert, the clearance with respect to positioning of the insert in the drill are varied and hence the lead angle.

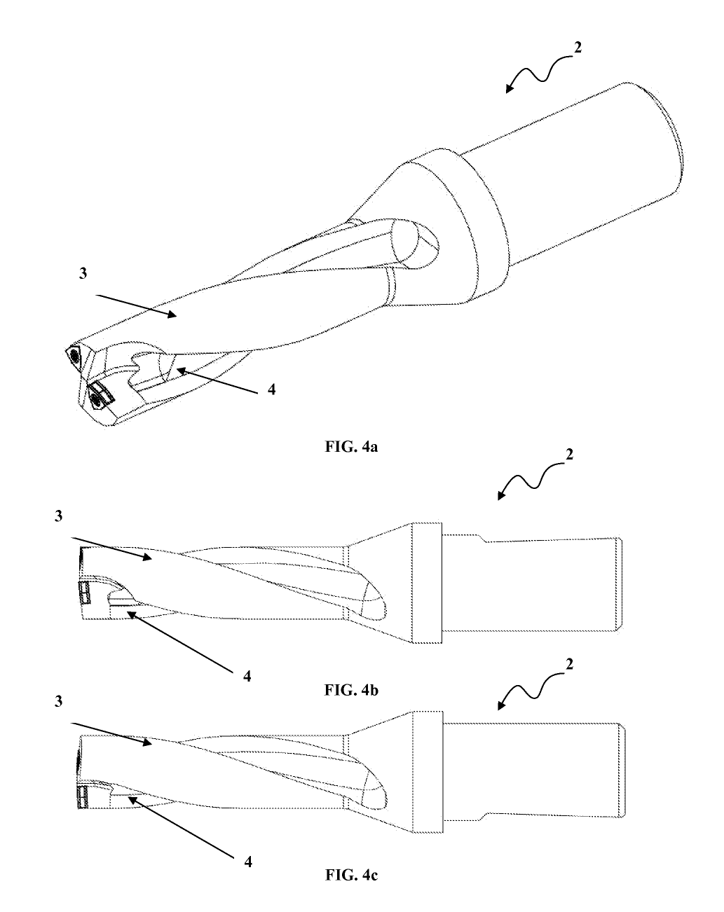

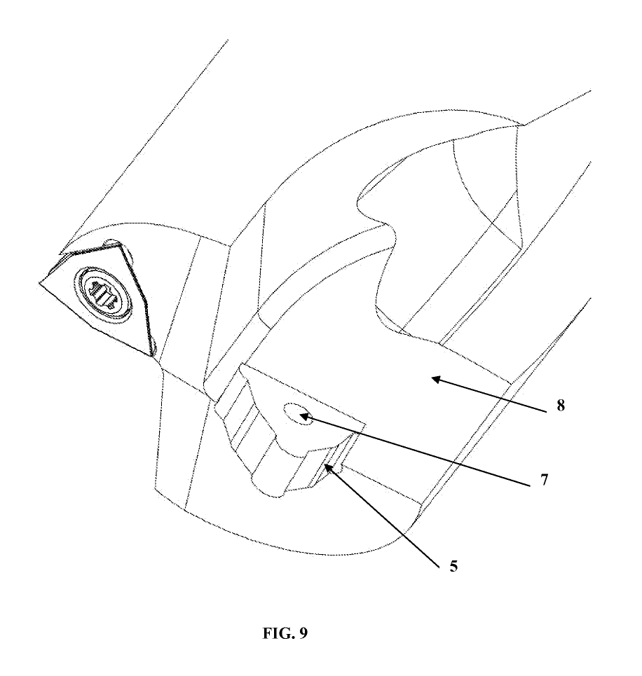

Is one embodiment, FIGS. 4a-4c illustrates perspective view and side views of the drilling tool according to the disclosure. The drilling body (2) is provided with two insert pockets (5), each one of which is provided with two contact surfaces (FIG. 9) against which a indexable drill insert (1) is arranged to be mounted by a screw (6). The screw (6) is screwed-in through the mounting hole (1a) of the drill insert (1) into a threaded fastening hole (7) in the drill insert pockets (5) of the drill body (8).

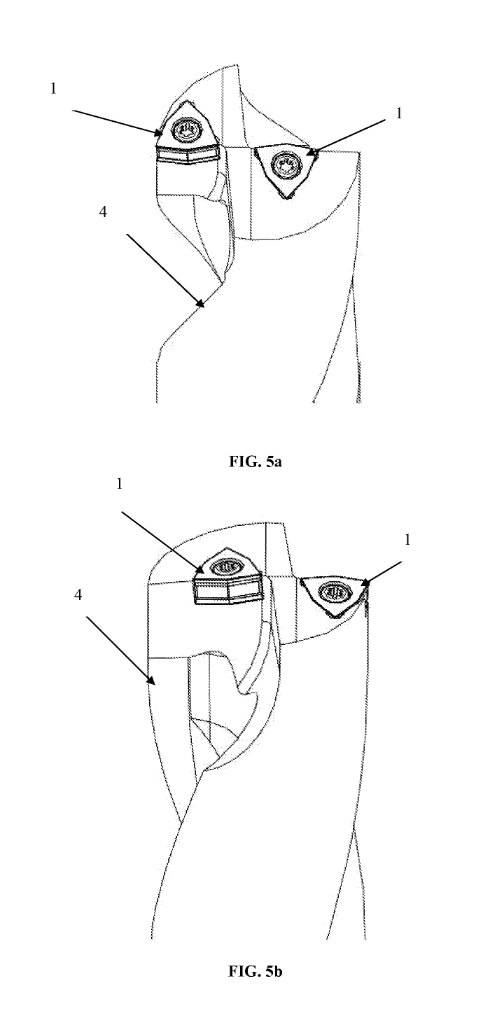

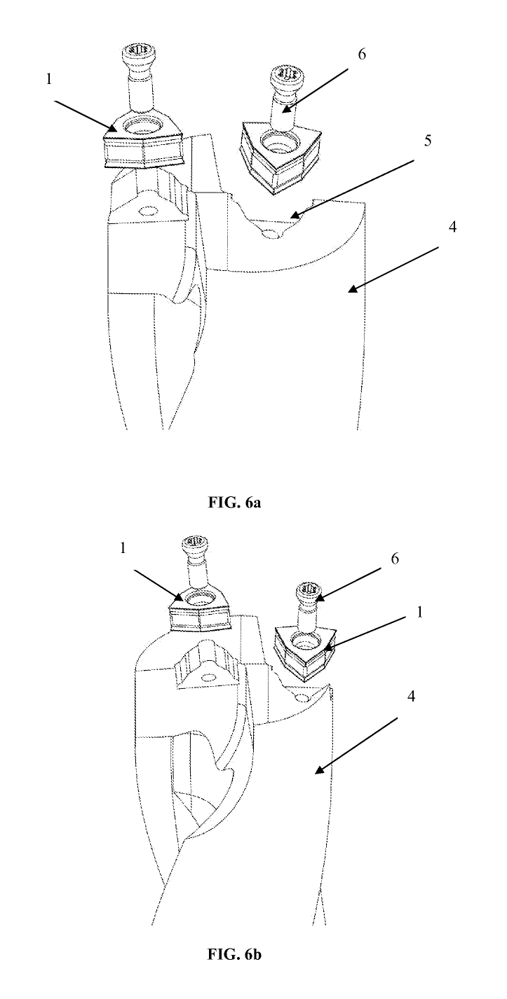

Is one embodiment, FIGS. 5a and 5b illustrate perspective views of assembled indexable drill insert (1) with drilling body (3) according to the disclosure. FIGS. 6a and 6b illustrates perspective views of assembling the indexable drill insert with drilling body according to the disclosure.

In one embodiment, the drill body (3) made of steel is built up on similar drill dynamics as Top cut plus drill or Drill Fix Trigon (DFT)/Drill Fix Square (DFS). The cutting end portion of the drill carries two of the above-discussed inserts. The inserts are tangentially mounted. The inner insert and the outer insert are so positioned that the drill forms a ‘cone’ angle, but not necessary that the angles formed by both the inserts positioning be the same. The inserts are so positioned that the axis of the inserts are substantially parallel to the drill axis, but with small angular orientations. These small angular orientations are provided so as to make up for all other clearance and lead angles like the cone angle, rake angle (Axial rake and Radial rake), etc. Hence, there will also be small amount of offsets between the axis of the insert screws and axis of the drill body.

The helix angle of the flutes is ranging from about 10° to about 30°. This is mainly to promote free and easy chip evacuation right from the cutting edge of the insert tips to the drill back end through the flutes.

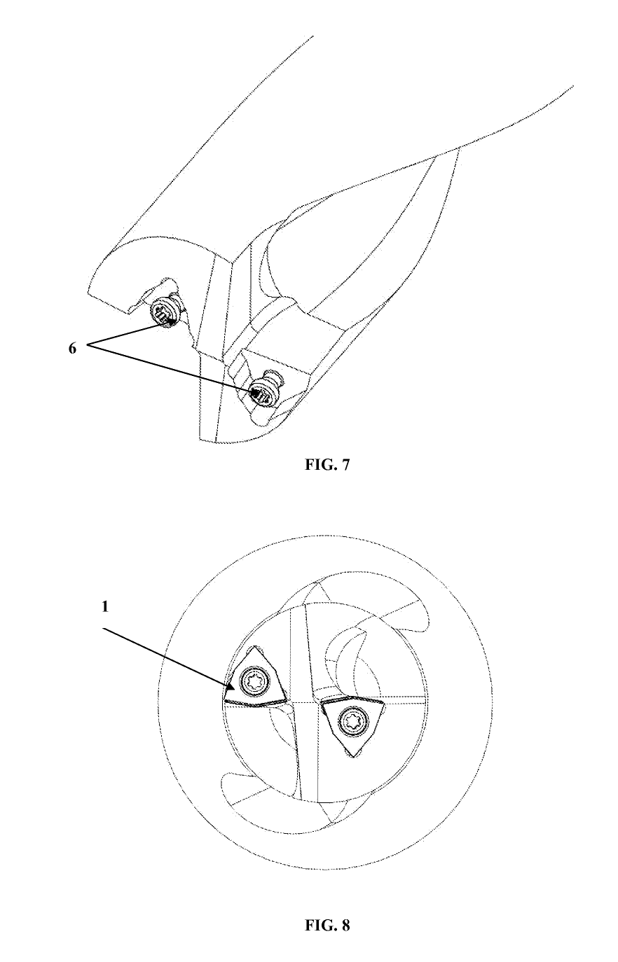

In one embodiment, FIG. 7 illustrates the drilling tool having fastening means parallel with the drilling tool axis according to the disclosure. The fastening means (6) [screws] are inserted into the drill inserts (1) to fasten with the drill body (3). Axis of the screw is substantially parallel to axis of the drill body.

In one embodiment, FIG. 8 illustrates an end view of the drill that illustrates tangential mounting of the Trigon shaped inserts. A tangential mounting implies that the screws are essentially mounted substantially parallel to the drill axis (FIG. 7). There is sufficient material for tapping in the drill body and hence screws of longer length may be used. This enables at least two or three complete threads to engage with the threads in the drill body. Hence, seating is more stable in case of tangential mounting. Also, since the contact faces in the axial direction are bigger, the transmission of axial component of cutting forces is more effective.

In one embodiment, the present disclosure provides for a method of indexing. The method comprises acts of unscrewing the insert from the drilling pockets, rotating the inserts about the mounting hole of the insert so that the adjacent faces as to the primary ones makes contact with the pocket wall and screwing back on the inserts with the drilling body. Once all the three cutting edges on one side of the insert are used up, the insert is unscrewed and inverted so that the other face contacts the pocket wall, and is screwed back on and thus the three cutting edges on other faces are also used.

In one embodiment, FIG. 9 illustrates seating faces in the pocket according to the instant disclosure. The contour of the seating faces provides stronger grip to the drill inserts. The chips after the drilling pass through the chip gash area (8) and through the helical flute.

### Equivalents:

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. An indexable drill insert (1) having trigon shape, comprising:
an upper side (1b) and lower side (1c), parallel to each other, characterized in that,
a mounting hole (1a) at center of the drill insert (1), enabling the indexable insert (1) to be mounted on both upper side (1b) and lower side (1c) of the insert (1); and
plurality of cutting edges (1d) on each side of the insert (1).

2. The indexable drill insert (1) as claimed in claim 1, wherein said insert (1) comprise six cutting edges and has included angle between adjacent cutting edge is ranging from about 70° to about 90°, and an angle between two parts of the same cutting edge ranging from about 140° to about 180°.

3. The indexable drill insert (1) as claimed in claim 1, wherein angle between upper side (1b) and a rake face is ranging from about 50° to about 90°.

4. The indexable drill insert (1) as claimed in claim 1, wherein the upper side (1b) and the lower side (1c) have three cutting edges (1d) each.

5. A drilling tool (2) comprising:
an indexable drill insert (1) having trigon shape, comprising an upper side (1b) and lower side (1c), parallel to each other, characterized in that, a mounting hole (1a) at center of the drill insert (1), enabling the insert (1) to be mounted on both upper side (1b) and lower side (1c) of the insert (1); and plurality of cutting edges (1d) on each side of the insert (1), and
a drill body (3) with drill flutes (4) and drill pockets (5) at the flute end, said drill pockets (5) are configured to accommodate to the indexable drill inserts (1);
wherein said indexable drill inserts (1) are tangentially mounted in the drill pockets (5).

6. The drilling tool (2) as claimed in claim 5, wherein said drill insert (1) comprise six cutting edges and has included-angle ranging from about 70° to about 90° and an angle between two parts of the same cutting edge ranging from about 140° to about 180°.

7. The drilling tool as claimed in claim 5, wherein the upper side (1a) and the lower side (1c) of the drill insert (1) has three cutting edges (1d) each.

8. A method of assembling drilling tool (2), comprising:
mounting indexable drill inserts (1) tangentially in drill pockets (5) of the drilling tool (2); and
fastening the indexable drill inserts (1) with the drilling tool (2) using screws (6).

9. The method as claimed in claim 8, wherein the drill inserts (1) are mounted in such a manner that axis of the screw (6) is substantially parallel to axis of the drilling tool (2).
